(19) United States
(12) Patent Application Publication
(10) Pub. No.: US 2007/0258466 A1
(43) Pub. Date: Nov. 8, 2007

(54) Reliable multicast/broadcast in a wireless network

(75) Inventor: Naveen K. Kakani, Irving, TX (US)

Correspondence Address: BRAKE HUGHES BELLERMANN LLP, c/o INTELLEVATE, P.O. BOX 52050, MINNEAPOLIS, MN, 55402, US

(73) Assignee: Nokia Corporation

(21) Appl. No.: 11/789,267

(22) Filed: Apr. 24, 2007

Related U.S. Application Data
(60) Provisional application No. 60/794,381, filed on Apr. 24, 2006.

(51) Int. Cl. H04L 12/28

(52) U.S. Cl. 370/395.53

(57) ABSTRACT

Various embodiments are disclosed relating to reliable multicast/broadcast in a wireless network. According to an example embodiment, an apparatus is provided in a wireless station. The apparatus may be adapted or configured to transmit a message in a wireless network from a recipient station to a transmitter station. The message may include a stream or traffic identifier (e.g., TID) associated with the recipient station for a multicast or broadcast stream. The apparatus may receive a reliable transmission of the multicast or broadcast stream from the transmitter station based upon the stream or traffic identifier.

This application claims priority based on U.S. Provisional Application No. 60/794,381, filed on Apr. 24, 2006, entitled, “RELIABLE MULTICAST/BROADCAST IN A WIRELESS NETWORK,” the disclosure of which is hereby incorporated by reference.

### BACKGROUND

The rapid diffusion of Wireless Local Area Network (WLAN) access and the increasing demand for WLAN coverage is driving the installation of a very large number of Access Points (AP). The most common WLAN technology is described in the Institute of Electrical and Electronics Engineers IEEE 802.11 family of industry specifications, such as specifications for IEEE 802.11b, IEEE 802.11g and IEEE 802.11a. A number of different 802.11 task groups are involved in developing specifications relating to improvements to the existing 802.11 technology. The IEEE 802.11n task group has developed a High Throughput (HT) draft specification, entitled “Wireless LAN Medium Access Control (MAC) and Physical Layer (PHY) specifications: Enhancements for Higher Throughput,” IEEE 802.11n.D0.01, January 2006.

In addition, data may be broadcast or multicast from a transmitter station to one or more recipient stations. A problem arises in wireless networks since such broadcast or multicast transmissions are typically unreliable.

### SUMMARY

Various embodiments are disclosed relating to reliable multicast/broadcast in a wireless network.

According to an example embodiment, an apparatus is provided in a wireless station. The apparatus may be adapted or configured to transmit a message in a wireless network from a recipient station to a transmitter station. The message may include a stream or traffic identifier (e.g., TID) associated with the recipient station for a multicast or broadcast stream. The apparatus may receive a reliable transmission of the multicast or broadcast stream from the transmitter station based upon the stream or traffic identifier.

According to another example embodiment, an apparatus is provided in a wireless station. The apparatus may be adapted or configured to transmit a message, such as an Add block acknowledgement request message for multicast/broadcast (Add BA-MB request message), in a wireless network from a recipient station to a transmitter station. The message may include a stream or traffic identifier (e.g., TID) associated with the recipient station for a multicast or broadcast stream. The apparatus may facilitate a reliable transmission of the multicast or broadcast stream from the transmitter station to the recipient station using the stream or traffic identifier.

According to another embodiment, a method is provided. The method may include transmitting a message from a recipient station to a transmitter station in a wireless network. The message may include a stream or traffic identifier (TID) associated with the recipient station for a multicast stream. The method may also include receiving at the recipient station from the transmitter a response to the message, and also receiving, by the recipient station, one or more data frames of the multicast stream from the transmitter station. The method may also include providing an acknowledgement by the recipient station to the transmitter station of receipt of one or more data frames of the multicast stream. The acknowledgement may include the TID associated with the recipient station, a sequence number (or starting sequence number) that is the same as a sequence number of one of the data frames received from the transmitter station, and a bit map identifying which of a plurality of data frames were received by the recipient station.

According to another example embodiment an apparatus is provided, e.g., in a transmitter station for wireless communication. The apparatus may include a controller, a memory coupled to the controller, and a wireless transceiver coupled to the controller. The apparatus may be adapted or configured to receive a message (such as, for example, an Add block acknowledgement request message for multicast/broadcast (Add BA-MB request message), or other message) from a recipient station. The message may include a stream identifier or traffic identifier (TID) associated with the recipient station for a multicast stream. The apparatus may also be adapted to provide a reliable transmission of the multicast stream from the transmitter station to the recipient station based upon the stream identifier. For example, providing a reliable transmission of a multicast stream may include, for example, transmitting data frames of the multicast stream to the recipient station, receiving one or more acknowledgements including the TID from the recipient station, and retransmitting as a unicast frame or multicast frame, to the recipient station, a data frame of the multicast stream for which an acknowledgement was not timely received.

According to yet another embodiment, a method is provided. The method may include receiving a message, at a transmitter station, from each of one or more multicast recipient stations in a wireless network. Each of the received messages may include a stream or traffic identifier (TID) associated with the recipient station for a multicast stream, an address of the recipient station, and multicast group address information. The multicast group address information may include a multicast group address or a hash or portion of the multicast group address, for example. The multicast group address information may identify a multicast group of which the recipient station is a member. The method may also include transmitting a response to the one or more recipient stations, and then transmitting one or more multicast data frames of the multicast stream to the one or more of the recipient stations. The method may further include receiving an acknowledgement from one or more of the recipient stations acknowledging receipt of one or more transmitted data frames of the multicast stream. The acknowledgement may include the TID associated with the recipient station, a sequence number (such as a starting sequence number), and an indication of which data frames were received by the recipient station. In an alternative embodiment, the method may include determining at the transmitter station that an acknowledgement was not received for one or more transmitted data frames of the multicast stream based on the acknowledgements, and then retransmitting one or more of the data frames of the multicast stream as unicast data frames to recipient stations associated with the TIDs.

In another example embodiment, a recipient station may signal or notify a transmitter station that it is requesting or requiring reliability for Multicast/Broadcast transmissions, and this request or notification for reliable multicast/broadcast may be made at the time when the recipient station begins or initiates communication with the transmitter station. For example, in a WLAN network, a station may indicate to an AP (access point) at the time of association that the station needs (or is requesting) reliable transmission of multicast/broadcast. In addition, when the transmitter station initiates a multicast/broadcast transmission, the transmitter station may transmit to one or more recipients of multicast data a unicast message specific to each recipient. Each of these received messages, received by the recipient stations, may include a particular stream or traffic identifier (TID) associated with the transmitter station for a multicast stream for the recipient station, an address of the transmitting station, and multicast group address information. The multicast group address information may include a multicast group address or a hash or portion of the multicast group address, for example. The multicast group address information may identify a multicast group of which the recipient station is a member. The method may also include a recipient station transmitting a response message to the transmitter station. The method also may include the transmitter station transmitting one or more multicast data frames of the multicast stream to the one or more of the recipient stations. The method may further include receiving an acknowledgement from one or more of the recipient stations acknowledging receipt of one or more transmitted data frames of the multicast stream. The acknowledgement may include the TID associated with the recipient station, a sequence number (such as a starting sequence number), and an indication of which data frames were received by the recipient station. In an alternative embodiment, the method may include determining, at the transmitter station, that an acknowledgement was not received for one or more transmitted data frames of the multicast stream based on the acknowledgements, and then retransmitting one or more of the data frames of the multicast stream as unicast data frames to recipient stations associated with the TIDs.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating a wireless network according to an example embodiment.

FIG. 2 is a timing diagram illustrating operation according to an example embodiment.

FIG. 3 is an example embodiment of Add Block Acknowledgement request/response frames for multicast/broadcast according to an example embodiment.

FIG. 4 is a diagram illustrating a block acknowledgement frame according to an example embodiment.

FIG. 5 is a flowchart illustrating operation of a multicast/broadcast recipient station according to an example embodiment.

FIG. 6 is a flowchart illustrating operation of a multicast/broadcast transmitter station according to an example embodiment.

FIG. 7 is a flowchart illustrating operation of a multicast/broadcast transmitter station according to another example embodiment.

FIG. 8 is a block diagram illustrating an apparatus that may be provided in a wireless node according to an example embodiment.

### DETAILED DESCRIPTION

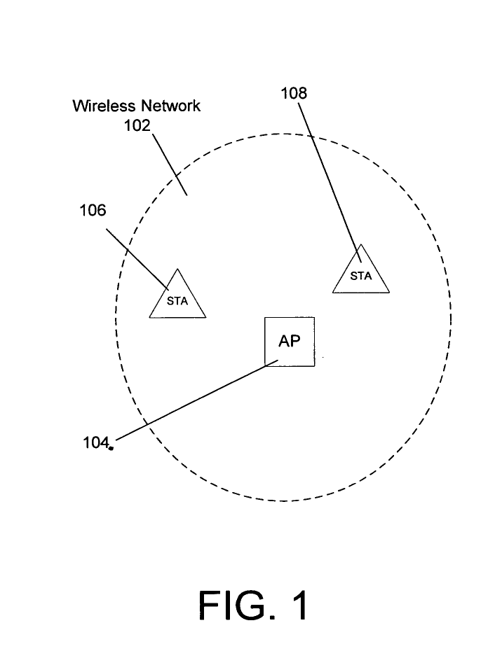

Referring to the Figures in which like numerals indicate like elements, FIG. 1 is a block diagram illustrating a wireless network according to an example embodiment. Wireless network 102 may include a number of wireless nodes or stations, such as an access point (AP) 104 or base station and one or more mobile stations, such as stations 106 and 108. While only one AP and two mobile stations are shown in wireless network 102, any number of APs and stations may be provided. Each station in network 102 (e.g., stations 106, 108) may be in wireless communication with the AP 104, and may even be in direct communication with each other. Although not shown, AP 104 may be coupled to a fixed network, such as a Local Area Network (LAN), Wide Area Network (WAN), the Internet, etc., and may also be coupled to other wireless networks.

The various embodiments described herein may be applicable to a wide variety of networks and technologies, such as WLAN networks (e.g., IEEE 802.11 type networks), IEEE 802.16 Wi MAX networks, cellular networks, radio networks, or other wireless networks. In another example embodiment, the various examples and embodiments may be applied, for example, to a mesh wireless network, where a plurality of mesh points (e.g., Access Points) may be coupled together via wired or wireless links. The various embodiments described herein may be applied to wireless networks, both in an infrastructure mode where an AP or base station may communicate with a station (e.g., communication occurs through APs), as well as an ad-hoc mode in which wireless stations may communicate directly via a peer-to-peer network, for example.

The terms “wireless node” or “node,” or “station” or the like, may include, for example, a wireless station, an access point (AP) or base station, a wireless personal digital assistant (PDA), a cell phone, an 802.11 WLAN phone, a wireless mesh point, or any other wireless device. These are merely a few examples of the wireless devices that may be used to implement the various embodiments described herein, and this disclosure is not limited thereto. The various embodiments herein may be applicable to so called infrastructure mode where a base station or AP may transmit information, as well as to ad-hoc mode.

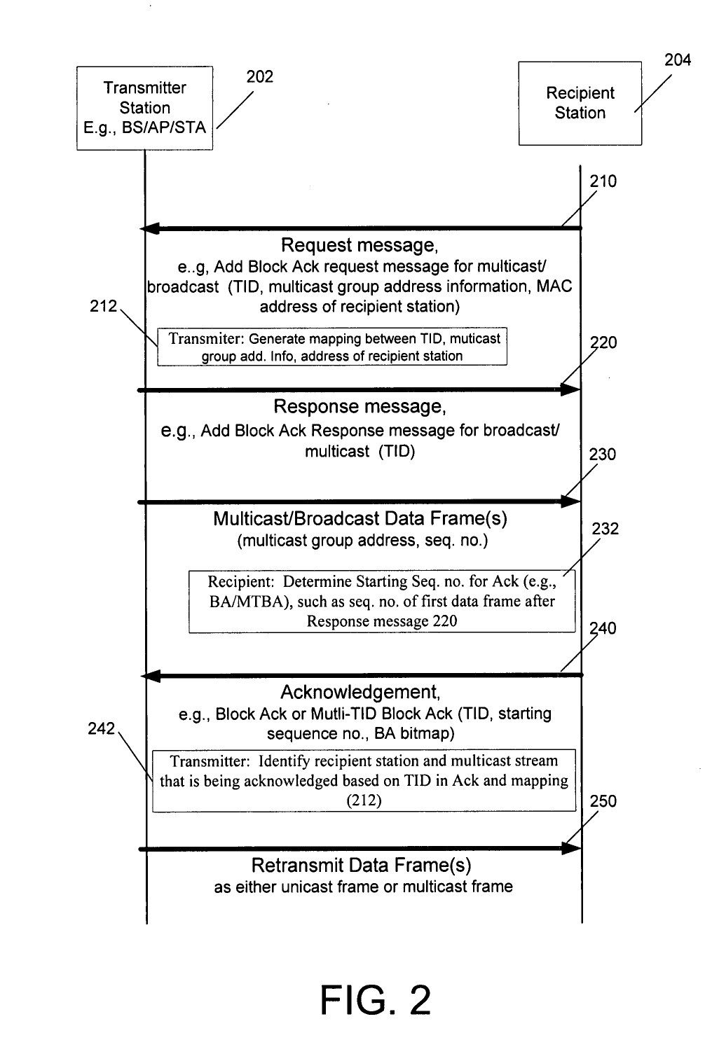

FIG. 2 is a timing diagram illustrating operation according to an example embodiment. A transmitter station 202 may be in wireless communication with one or more recipient stations, such as recipient station 204. Transmitter station 202 may, for example, transmit one or more multicast or broadcast streams to one or more recipient stations. For example, a multicast stream may be directed to a group of stations which may be members of a multicast group, and which may be identified by a multicast group address. Transmitter station 202 and recipient station 204 may be any type of stations. For example, transmitter station 202 may be a base station, access point (AP), wireless station in ad-hoc mode, or other wireless node, while recipient station 204 may be any type of wireless node.

Referring to FIG. 2, recipient station 204 may transmit a request message 210 to transmitter station 202, such as, for example, an Add block Acknowledgement request message for multicast/broadcast (Add BA-MB request message). This is merely an example, and other messages may be used. The message 210 (e.g., Add BA-MB request message) may be transmitted, for example, to perform a block acknowledgement set up for a multicast or broadcast stream to allow reliable transmission from the transmitter station 202 to the recipient station 204.

Note, although not limited thereto, in an example embodiment, the term “broadcast” may refer to a transmission of a frame or message to all stations, while “multicast” may refer to a transmission of a frame or message to a group of stations. The term “multicast” may generally include a transmission to all stations or to a group or sub-set of stations. Thus, the term “multicast” may include both multicast and broadcast.

The message 210 may include, for example, a stream or traffic identifier (TID) associated with recipient station 204 for the multicast stream, multicast group address information which may include the multicast group address for the multicast stream, or a portion or a derivation or a hash of the multicast group address, for example. The message 210 may also include an address of the recipient station 204 that is transmitting the message, such as a medium access control (MAC) address of the recipient station 204, for example.

At 212, the transmitter station 202 may generate a mapping or association between the TID, the multicast stream (or multicast group address information), and the address (e.g., MAC address) of the recipient station 204. In this manner, by receiving the TID within message 210, a reliable multicast transmission may be facilitated or assisted. For example, a reliable multicast transmission may be facilitated or assisted because transmitter station 202 may be able to match received acknowledgements to specific multicast streams and recipient stations based on this mapping between TID and the recipient station address and multicast group address information.

The transmitter station 202 may transmit, in response to request message 210, a response message 220, such as, for example, an Add block acknowledgement response message for multicast/broadcast (Add BA-MB response message), and may include the TID.

One or more multicast or broadcast data frames 230 may be transmitted from the transmitter station 202 to a plurality of recipient stations, including recipient station 204. The multicast data frames 230 transmitted to recipient station 204 may include a multicast group address and a sequence number, among other fields.

At 232, recipient station 204 may determine a starting sequence number for its acknowledgement based upon a sequence number of the one or more data frames received after receipt of response message 220. In an example embodiment, recipient station 204 may set its starting sequence number of its acknowledgement to the sequence number of the first data frame of the multicast stream received after receipt of response message 220.

Recipient station 204 may then transmit an acknowledgement 240, such as a block acknowledgement or a multiple TID block acknowledgement (MTBA) for multicast/broadcast. Acknowledgement 240 may include the TID associated with recipient station 204 for the multicast stream, a starting sequence number, and an indication of which of a plurality of multicast data frames were received. For example, the acknowledgement 240 may include a block Ack (BA) bitmap, having a bit indicating, for each of a plurality of data frames starting with the starting sequence number, whether the data frame was received (e.g., a 1 acknowledging receipt, and a 0 not acknowledging receipt).

Each recipient station that is receiving the multicast stream may perform a block acknowledgement setup for multicast (including messages 210 and 22) to allow reliable transmission from the transmitter station 202 at a different point or time during the multicast stream. Therefore, depending on timing of when each stations perform a block acknowledgement setup for multicast, each recipient station may independently determine a starting sequence number for its acknowledgement, which may be different from the starting sequence numbers used by other recipient stations.

After sending an acknowledgement 240, the recipient station 204 may, for example, update its starting sequence number, to be used for next acknowledgement 240, to the sequence number of the highest or last data frame acknowledged.

Transmitter station 202 may receive acknowledgements from recipient station 204, as well as from other recipient stations. At 242, the transmitter station 202 may identify the recipient station and the multicast stream for which frames are being acknowledged by acknowledgement 240, based upon the TID in the acknowledgement and the mapping (from 212), for example.

For one or more data frames in the multicast stream which are not acknowledged, transmitter station 202 may retransmit these data frames 250 to recipient station 204, e.g., either as a unicast frame or a multicast frame. Retransmitted data frames 250 may be sent as unicast frames since the transmitter station may obtain or determine the multicast stream and the MAC address or other address of the recipient station 204 based on the TID in the acknowledgement and the mapping (from 212), for example. This may allow a reliable multicast stream via acknowledgements and retransmission via unicast data frames to specific multicast stream recipient stations that did not receive the frame, for example.

Alternatively, for example, where multiple recipient stations may not have received a specific data frame of the multicast stream (e.g., a timeout occurs before acknowledgement is received for such frame for a plurality of recipient stations), transmitter station 202 may retransmit such data frame as a multicast data frame addressed to the multicast address. These are merely two examples of how reliable transmission for multicast/broadcast may be used, and the embodiments are not limited to these examples.

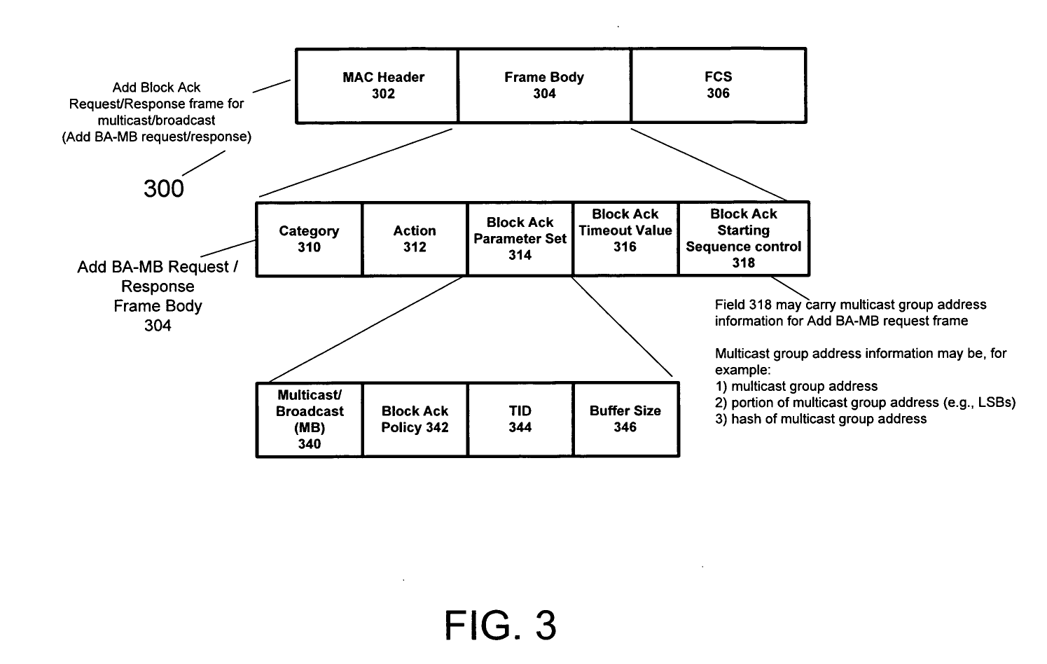

FIG. 3 is an example embodiment of an Add Block Acknowledgement request frame for multicast (Add BA-MB request) and an Add Block Acknowledgement response frame for multicast (Add BA-MB response). The Add BA-MB request and response messages (or frames) may have a same or similar format. The Add BA-MB request/response frame 300 may include a MAC header 302, which may include a recipient station address, a transmitter station address, and other fields. The frame 300 may also include a frame body 304 and a frame check sequence 306.

Add BA-MB request/response frame body 304 may include a number of fields, including category field 310, which may be set to a value indicating block Ack (acknowledgement), and action field 312, which may be set to a value indicating Add BA-MB request or response message, depending on whether it is a request or response.

Frame body 304 also include a block Ack parameter set 314, a block Ack timeout value 316, and a block Ack starting sequence control field 318. Block Ack parameter set 314 may include a field 340 indicating multicast/broadcast (MB), a block Ack policy 342 identifying the block acknowledgement policy, a traffic (or stream) identifier (TID) to identify a (station-specific) TID associated with a recipient station for a multicast/broadcast stream, and a buffer size field 346.

Block Ack starting sequence control field 318 may be used to provide a BA starting sequence number. However, in an example embodiment, the control field 318 may be used to carry multicast group address information for Add BA-MB request frame. The multicast or broadcast group address information may include, for example, either multicast or broadcast group address for a stream, a portion of the multicast/broadcast group address (e.g., LSBs), or a hash of the multicast/broadcast address, or other multicast/broadcast address related information.

Table 1 below illustrates example Action Field values (for Action field 312), including a value of 0 for Add BA request (unicast), a value of 1 for Add BA response (unicast), a value of 3 for Add BA-MB request (for multicast/broadcast), and a value of 4 for Add BA-MB response (for multicast/broadcast).

Alternatively, rather than providing separate Add BA request and response messages (frames) for unicast and for broadcast/multicast as shown in Table 1, the Add BA request/response frames for unicast may be re-used for multicast/broadcast, with the multicast/broadcast field 340 (set the field to 1) provided in block Ack parameter set 314 to indicate multicast/broadcast.

TABLE 1

| Action Field Values | Meaning |
|---|---|
| 0 | ADD BA request |
| 1 | ADD BA response |
| 2 | DELBA |
| 3 | ADD BA-MB request |
| 4 | ADD BA-MB response |
| 5–255 | Reserved |

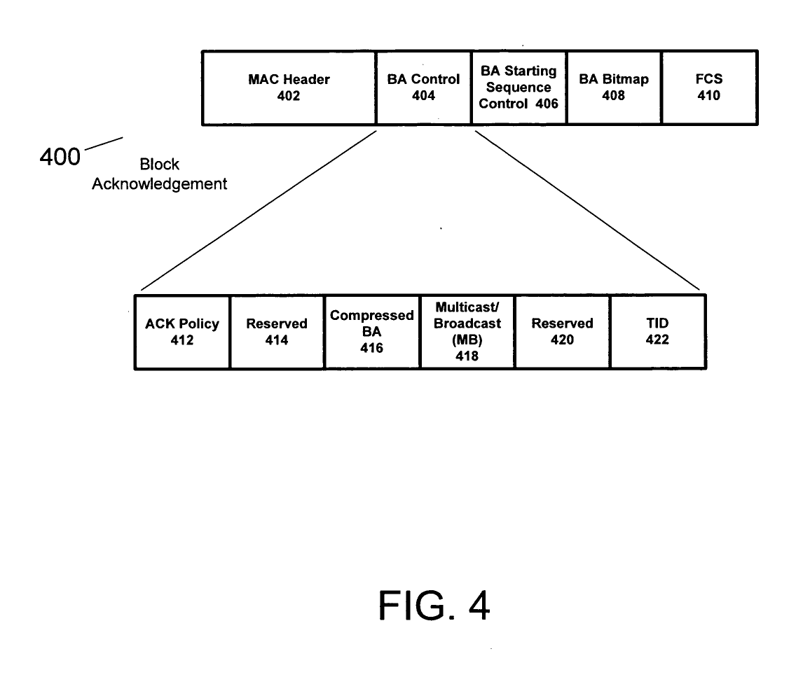

FIG. 4 is a diagram illustrating a block acknowledgement frame according to an example embodiment. Block acknowledgement (Block Ack) 400 may include a MAC header 402, which may include transmitter station address and recipient station address, and a BA control field 404. A BA starting sequence control field 406 may include a starting sequence number. A BA bitmap 408 may provide an indication for each of a plurality of multicast/broadcast data frames whether the frame was received by the recipient station, e.g., beginning with the data frame identified by the starting sequence number. A frame check sequence (FCS) field 410 may also be provided.

BA control field 404 may include an Ack policy field 412 to identify an Ack policy, reserved fields 414 and 420, a compressed block Ack field 416, and a multicast/broadcast (MB) field 418 indicating block Ack for multicast/broadcast data frame. A TID field 422 identifies a stream or traffic identifier associated with the recipient station for a multicast or broadcast stream or for a multicast group address.

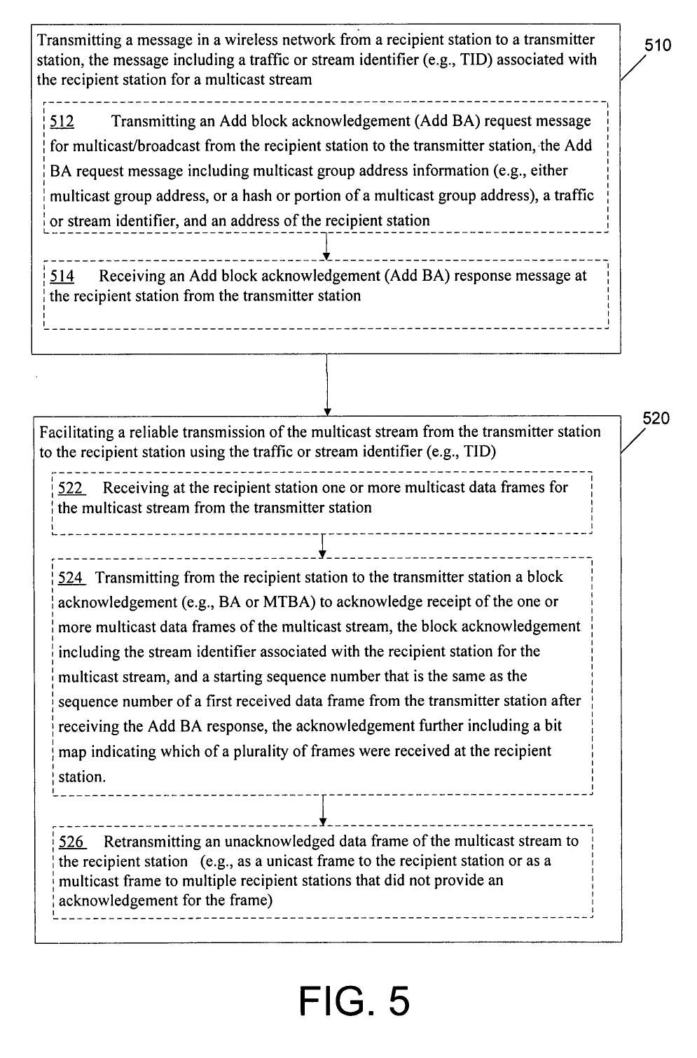

FIG. 5 is a flowchart illustrating operation of a multicast/broadcast recipient station according to an example embodiment. At 510, a message may be transmitted in a wireless network from a recipient station to a transmitter station. The message may include a traffic or stream identifier (e.g., TID) associated with the recipient station for a multicast stream.

Operation 510 may include, for example: transmitting (512) an Add block acknowledgement request message for multicast/broadcast (Add BA-MB request) from the recipient station to the transmitter station. The Add BA-MB request message may include multicast group address information (e.g., either multicast group address, or a hash or portion of a multicast group address), a traffic or stream identifier (TID), and an address of the recipient station. Operation 510 may also include receiving (514) an Add block acknowledgement (Add BA) response message for multicast/broadcast (Add BA-MB response) at the recipient station from the transmitter station.

At 520, a reliable transmission of the multicast stream from the transmitter station to the recipient station may be facilitated using or based upon the traffic or stream identifier (TID).

Operation 520 may include, for example: receiving (522) at the recipient station one or more multicast data frames for the multicast stream from the transmitter station, and transmitting (524) from the recipient station to the transmitter station a block acknowledgement (e.g., BA or MTBA) to acknowledge receipt of the one or more multicast data frames of the multicast stream. The block acknowledgement may include the traffic or stream identifier associated with the recipient station for the multicast stream, and a starting sequence number that is the same as the sequence number of a first received data frame from the transmitter station after receiving the Add BA response. The acknowledgement may also include a bit map indicating which of a plurality of frames were received at the recipient station. Operation 520 may also include retransmitting (526) an unacknowledged data frame of the multicast stream to the recipient station (e.g., as a unicast frame to the recipient station or as a multicast frame to multiple recipient stations that did not provide an acknowledgement for the frame).

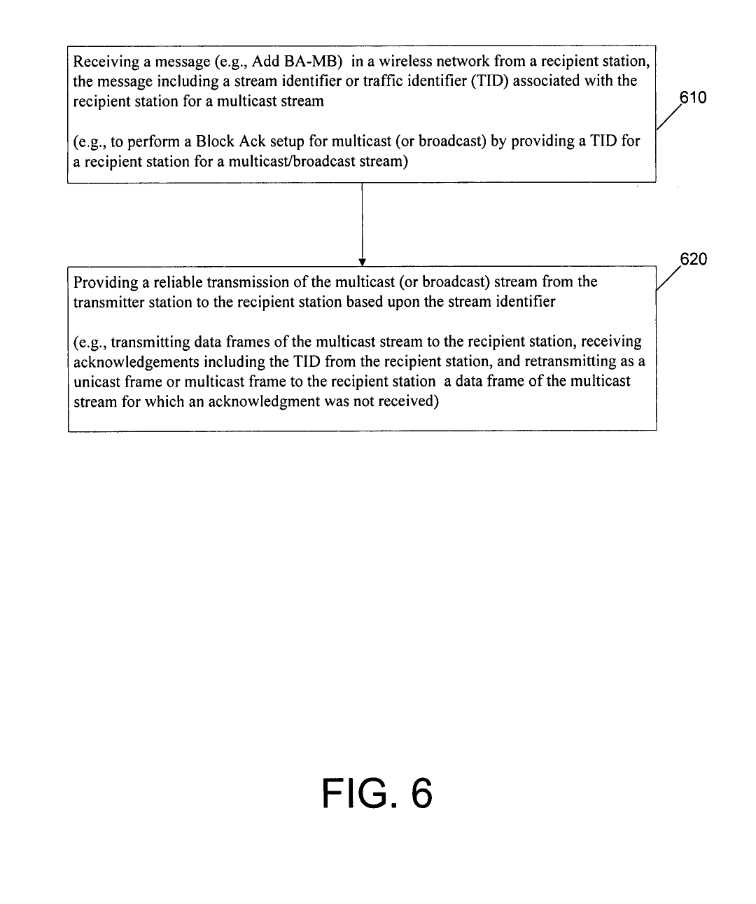

FIG. 6 is a flowchart illustrating operation of a multicast/broadcast transmitter station according to an example embodiment. At 610, a message (e.g., Add BA-MB request message) may be received from a recipient station. The received message may include a stream identifier or traffic identifier (TID) associated with the recipient station for a multicast stream. The Add BA-MB request message may be used, for example, to perform a Block Ack setup for multicast (or broadcast) by providing a TID for a recipient station for a multicast/broadcast stream.

At 620, a reliable transmission of the multicast (or broadcast) stream may be provided from the transmitter station to the recipient station based upon the traffic or stream identifier (e.g., TID). Operation 620 may include, for example, transmitting data frames of the multicast stream to the recipient station, receiving acknowledgements including the TID from the recipient station, and retransmitting as a unicast frame or multicast frame to the recipient station a data frame of the multicast stream for which an acknowledgement was not received.

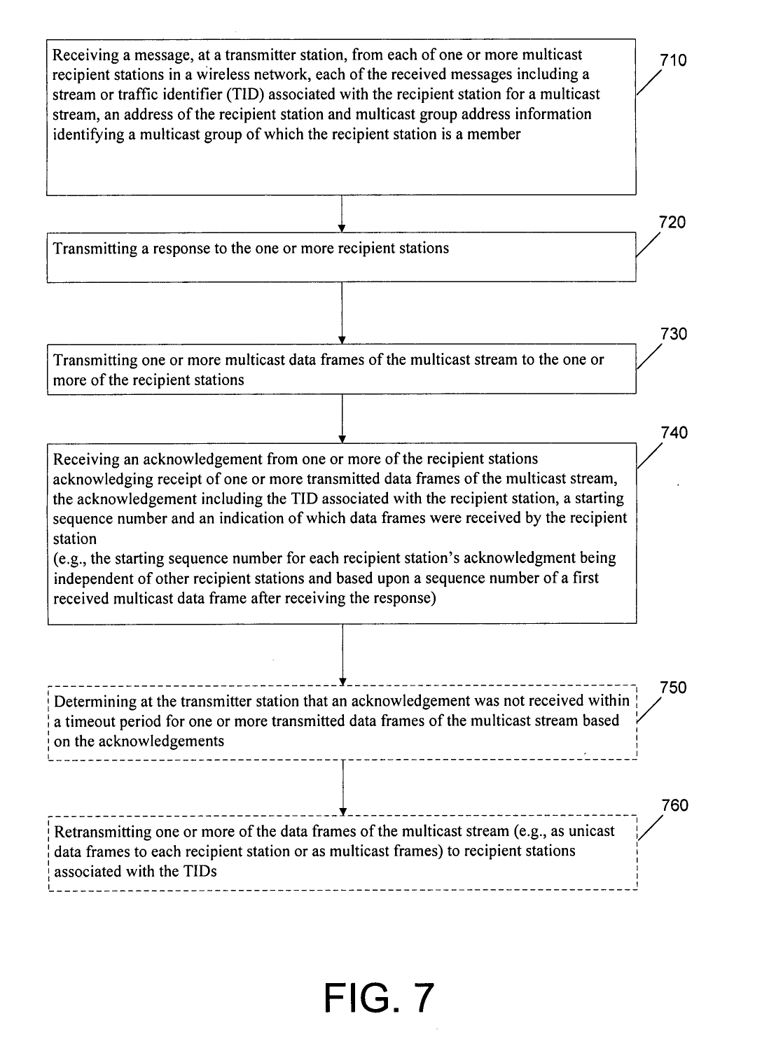

FIG. 7 is a flowchart illustrating operation of a multicast/broadcast transmitter station according to another example embodiment. At 710, a message is received at a transmitter station, from each of one or more multicast recipient stations in a wireless network. Each of the received messages may include a stream or traffic identifier (TID) associated with the recipient station for a multicast stream, an address of the recipient station, and multicast group address information identifying a multicast group of which the recipient station is a member.

At 720, a response is transmitted to the one or more recipient stations. At 730, one or more multicast data frames of the multicast stream are transmitted to the one or more of the recipient stations.

At 740, an acknowledgement from one or more of the recipient stations may be received acknowledging receipt of one or more transmitted data frames of the multicast stream. The acknowledgement may include the TID associated with the recipient station, a starting sequence number and an indication of which data frames were received by the recipient station. In an example embodiment, the starting sequence number for each recipient station's acknowledgement may be independent (or determined independently) of other recipient stations, and may be based upon a sequence number of a first received multicast data frame after receiving the response, for example.

At 750, the transmitter station may determine that an acknowledgement was not received within a timeout period for one or more transmitted data frames of the multicast stream based on the acknowledgements. At 760, retransmitting one or more of the data frames of the multicast stream may be retransmitted (e.g., as unicast data frames to each recipient station or as multicast frames) to recipient stations associated with the TIDs. Thus, in this manner, as noted in the various example embodiments described above, a reliable multicast or broadcast transmission may be provided.

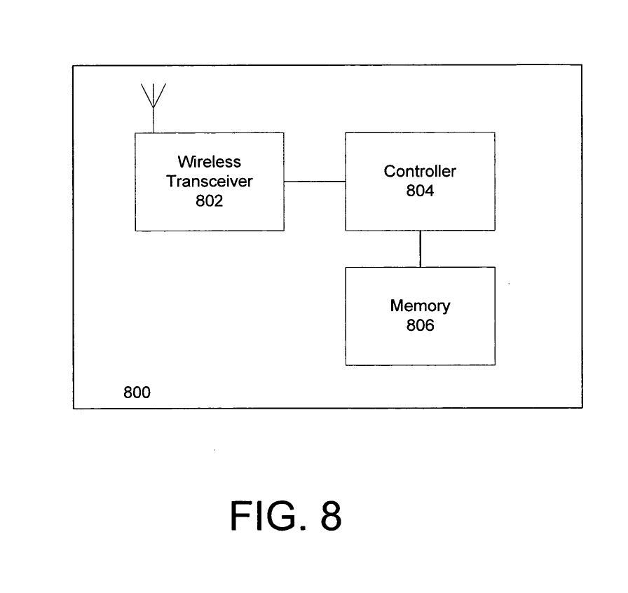

FIG. 8 is a block diagram illustrating an apparatus 800 that may be provided in a wireless node according to an example embodiment. The wireless node (e.g. station or AP) may include, for example, a wireless transceiver 802 to transmit and receive signals, a controller 804 to control operation of the station and execute instructions or software, and a memory 806 to store data and/or instructions.

Controller 804 may be programmable and capable of executing software or other instructions stored in memory or on other computer media to perform the various tasks and functions described above.

In addition, a storage medium may be provided that includes stored instructions, when executed by a controller or processor that may result in the controller 804, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. An apparatus provided in a wireless station, the apparatus adapted to:
transmit a message in a wireless network from a recipient station to a transmitter station, the message including a stream or traffic identifier associated with the recipient station for a multicast or broadcast stream; and
receive a reliable transmission of the multicast or broadcast stream from the transmitter station to the recipient station based upon the stream or traffic identifier.

2. An apparatus provided in a wireless station, the apparatus adapted to:
transmit a message in a wireless network from a recipient station to a transmitter station, the message including a stream or traffic identifier associated with the recipient station for a multicast stream; and
facilitate a reliable transmission of the multicast stream from the transmitter station to the recipient station using the stream or traffic identifier.

3. The apparatus of claim 2 wherein the apparatus adapted to transmit comprises the apparatus adapted to:
transmit an Add block acknowledgement (Add BA) request message from the recipient station to the transmitter station, the Add BA request message including multicast group address information, a traffic identifier or stream identifier, and an address of the recipient station; and
receive an Add block acknowledgement (Add BA) response message at the recipient station from the transmitter station.

4. The apparatus of claim 2 wherein the apparatus being adapted to facilitate a reliable transmission of the multicast stream comprises the apparatus adapted to:
receive one or more multicast data frames; and
transmit an acknowledgement from the recipient station to the transmitter station including the stream or traffic identifier associated with the recipient station, and an indication of which data frames were received at the recipient station.

5. A method comprising:
transmitting a message in a wireless network from a recipient station to a transmitter station, the message including a stream identifier associated with the recipient station for a multicast stream; and
facilitating a reliable transmission of the multicast stream from the transmitter station to the recipient station using the stream identifier.

6. The method of claim 5 and further comprising:
the transmitter station associating or mapping the stream identifier associated with the recipient station, the multicast stream, and the recipient station.

7. The method of claim 5 wherein the facilitating the reliable transmission comprises:
receiving at the recipient station one or more multicast data frames for the multicast stream; and
providing by the recipient station to the transmitter station an acknowledgement of the receipt of the one or more multicast data frames, the acknowledgement including the stream identifier associated with the recipient station for the multicast stream.

8. The method of claim 5 wherein the facilitating comprises the recipient station providing a block acknowledgement to acknowledge receipt of one or more data frames, the block acknowledgement including the stream identifier associated with the recipient station for the multicast stream.

9. The method of claim 8 wherein the block acknowledgement provided by the recipient station to the transmitter station includes a starting sequence number associated with a data frame and a block acknowledgement bit map identifying which of a plurality of data frames were received.

10. The method of claim 5 wherein the facilitating comprises the recipient station providing a multiple traffic stream block acknowledgement to acknowledge receipt of one or more of data frames for each of a plurality of multicast streams, the multiple traffic stream block acknowledgement including stream identifiers associated with the recipient station for each of the plurality of multicast streams.

11. The method of claim 5 wherein the facilitating a reliable transmission comprises:
receiving at the recipient station one or more multicast data frames for the multicast stream;
providing by the recipient station to the transmitter station an acknowledgement of the receipt of the one or more multicast data frames, the acknowledgement including the stream identifier associated with the recipient station for the multicast stream; and
the transmitter station selectively retransmitting at least some of the data frames based on the acknowledgement.

12. The method of claim 11 wherein the transmitter station selectively retransmitting comprises the transmitter station selectively retransmitting at least one data frame as a unicast data frame to the recipient station.

13. The method of claim 11 wherein the transmitter station selectively retransmitting comprises the transmitter station selectively retransmitting at least one data frame as a multicast data frame to the recipient station.

14. The method of claim 5 wherein the facilitating the reliable transmission comprises:
receiving at the recipient station one or more multicast data frames for the multicast stream; and
transmitting from the recipient station to the transmitter station an acknowledgement of the receipt of the one or more multicast data frames, the acknowledgement including the stream identifier associated with the recipient station for the multicast stream, a sequence number that is the same as the sequence number of a first received data frame from the transmitter station after receiving a response to the message, the acknowledgement further including a bit map indicating which of a plurality of frames were received at the recipient station.

15. The method of claim 5 wherein the transmitting comprises:
transmitting an Add block acknowledgement (Add BA) request message from the recipient station to the transmitter station, the Add BA request message including multicast group address information, a traffic identifier or stream identifier, and an address of the recipient station; and
receiving an Add block acknowledgement (Add BA) response message at the recipient station from the transmitter station.

16. The method of claim 15 wherein the facilitating comprises:
receiving at the recipient station one or more multicast data frames for the multicast stream; and
transmitting from the recipient station to the transmitter station a block acknowledgement to acknowledge receipt of the one or more multicast data frames of the multicast stream, the block acknowledgement including the stream identifier associated with the recipient station for the multicast stream, and a sequence number that is the same as the sequence number of a first received data frame from the transmitter station after receiving the Add BA response, the acknowledgement further including a bit map indicating which of a plurality of frames were received at the recipient station.

17. The method of claim 16 wherein the bit map identifies an unacknowledged data frame, the method further comprising:
determining the recipient station's address based on the traffic or stream identifier in the block acknowledgement and a mapping between the traffic or stream identifier and the address of the recipient station; and
retransmitting the unacknowledged data frame from the multicast stream as a unicast frame to the recipient station using the recipient station's address.

18. The method of claim 15 and further comprising:
the transmitter station associating or mapping the multicast group address information, the stream or traffic identifier, and the address of the recipient.

19. A method comprising:
transmitting a message from a recipient station to a transmitter station in a wireless network, the message including a stream or traffic identifier (TID) associated with the recipient station for a multicast stream;
receiving at the recipient station from the transmitter a response to the message;
receiving, by the recipient station, one or more data frames of the multicast stream from the transmitter station; and
providing an acknowledgement by the recipient station to the transmitter station of receipt of one or more data frames of the multicast stream, the acknowledgement including the TID associated with the recipient station, a sequence number that is the same as a sequence number of one of the data frames received from the transmitter station, and a bit map identifying which data frames were received by the recipient station.

20. The method of claim 19 wherein the sequence number provided in the acknowledgement is the same as the sequence number of a first received data frame after receiving the response.

21. The method of claim 19:
wherein the transmitting the message comprises transmitting an Add block acknowledgement for multicast/broadcast (Add BA-MB) request message, the Add BA-MB request message including a multicast group address, a TID, and a MAC address of the recipient station;
wherein the receiving the response comprises receiving an Add BA-MB response message at the recipient station from the transmitter station; and
wherein the providing comprises providing a block acknowledgement by the recipient station to the transmitter station of receipt of one or more data frames of the multicast stream, the acknowledgement including the TID associated with the recipient station, a sequence number that is the same as a sequence number of a first data frame received from the transmitter station after the response, and a bit map identifying which data frames were received by the recipient station.

22. An apparatus provided in a transmitter station for wireless communication, the apparatus comprising:
a controller;
a memory coupled to the controller; and
a wireless transceiver coupled to the controller; and
the apparatus adapted to:
receive a message in a wireless network from a recipient station, the message including a stream identifier or traffic identifier (TID) associated with the recipient station for a multicast stream; and
provide a reliable transmission of the multicast stream from the transmitter station to the recipient station based upon the stream identifier.

23. The apparatus of claim 22 wherein the apparatus is further adapted to receive a reliable multicast request message from the recipient station indicating that the recipient station needs or is requesting reliable transmission of the multicast or broadcast stream.

24. The apparatus of claim 22 wherein the apparatus being adapted to receive the message comprises the apparatus being adapted to receive an Add block acknowledgement (Add BA) request message from the recipient station including the TID associated with the recipient station for the multicast stream.

25. The apparatus of claim 22 wherein the apparatus being adapted to provide reliable transmission comprises the apparatus adapted to:
transmit one or more multicast data frames to the recipient station;
receive an acknowledgement from the recipient station including the TID and an indication of which data frames were received; and
retransmit one or more data frames of the multicast stream to the recipient station as either unicast frames addressed to the recipient station or multicast frames.

26. A method comprising:
receiving a message, at a transmitter station, from each of one or more multicast recipient stations in a wireless network, each of the received messages including a stream or traffic identifier (TID) associated with the recipient station for a multicast stream, an address of the recipient station and multicast group address information identifying a multicast group of which the recipient station is a member;
transmitting a response to the each of one or more recipient stations;
transmitting one or more multicast data frames of the multicast stream to one or more of the recipient stations; and
receiving an acknowledgement from the one or more of the recipient stations acknowledging receipt of one or more transmitted data frames of the multicast stream, the acknowledgement including the TID associated with the recipient station, a sequence number and an indication of which data frames were received by the recipient station.

27. The method of claim 26 and further comprising:
determining at the transmitter station that an acknowledgement was not received within a timeout period for one or more transmitted data frames of the multicast stream based on the acknowledgement; and
retransmitting one or more of the data frames of the multicast stream as unicast data frames to recipient stations associated with the TIDs.
